(19) United States
(12) Patent Application Publication
(10) Pub. No.: US 2021/0110346 A1
(43) Pub. Date: Apr. 15, 2021

(54) CENTRALIZED COMMUNICATIONS FOR A PROJECT PORTFOLIO MANAGEMENT PLATFORM

(71) Applicant: Planisware SAS, Chatillon (FR)

(72) Inventors: Pierre Demonsant, Paris (FR); Amélie Cochet-Grasset, Paris (FR)

(73) Assignee: Planisware SAS, Chatillon (FR)

(21) Appl. No.: 17/064,558

(22) Filed: Oct. 6, 2020

Related U.S. Application Data
(60) Provisional application No. 62/911,868, filed on Oct. 7, 2019.

(51) Int. Cl. G06Q 10/10; G06F 16/21; G06F 16/22

(52) U.S. Cl. CPC G06Q 10/103; G06Q 10/107; G06F 16/22; G06F 16/21

(57) ABSTRACT

Techniques and mechanisms described herein provide for centralized communication for a project portfolio management platform.

### CROSS-REFERENCE TO RELATED APPLICATIONS

This application claims the benefit of U.S. Provisional Application No. 62/911,868, filed Oct. 7, 2019, entitled “CENTRALIZED COMMUNICATIONS FOR A PROJECT PORTFOLIO MANAGEMENT PLATFORM,” which is incorporated herein by reference in its entirety for all purposes.

### TECHNICAL FIELD

The present disclosure relates to digital communication for a project portfolio management platform.

### COPYRIGHT NOTICE

A portion of the disclosure of this patent document contains material which is subject to copyright protection. The copyright owner has no objection to the facsimile reproduction by anyone of the patent document or the patent disclosure as it appears in the United States Patent and Trademark Office patent file or records but otherwise reserves all copyright rights whatsoever.

### DESCRIPTION OF RELATED ART

Project Portfolio management systems enable different people of an organization to connect, process, and focus on information about a project or portfolio. There can be a tremendous amount of information generated about those projects and portfolios. Accordingly, improved techniques for communicating within a project portfolio management platform are desired.

### BRIEF DESCRIPTION OF THE DRAWINGS

The disclosure may best be understood by reference to the following description taken in conjunction with the accompanying drawings, which illustrate particular embodiments of the present invention.

FIG. 1 illustrates one example of a flow process diagram

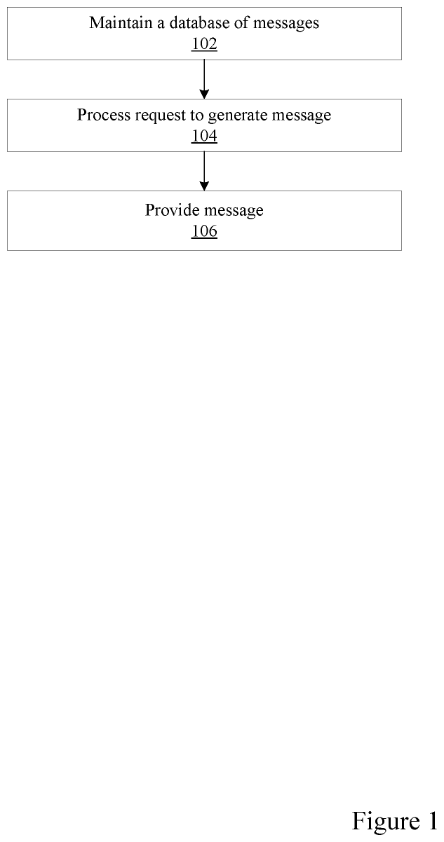

FIG. 2 illustrates one example of a computer system.

### DETAILED DESCRIPTION

Reference will now be made in detail to some specific examples of the invention including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims.

For example, the techniques of the present invention will be described in the context of a particular computing environment, e.g., a project portfolio management platform. However, it should be noted that the techniques of the present invention apply to a wide variety of computing environments. In the following description, numerous specific details are set forth in order to provide a thorough understanding of the present invention. Particular example embodiments of the present invention may be implemented without some or all of these specific details. In other instances, well known process operations have not been described in detail in order not to unnecessarily obscure the present invention.

Various techniques and mechanisms of the present invention will sometimes be described in singular form for clarity. However, it should be noted that some embodiments include multiple iterations of a technique or multiple instantiations of a mechanism unless noted otherwise. For example, a system uses a processor in a variety of contexts. However, it will be appreciated that a system can use multiple processors while remaining within the scope of the present invention unless otherwise noted. Furthermore, the techniques and mechanisms of the present invention will sometimes describe a connection between two entities. It should be noted that a connection between two entities does not necessarily mean a direct, unimpeded connection, as a variety of other entities may reside between the two entities. For example, a processor may be connected to memory, but it will be appreciated that a variety of bridges and controllers may reside between the processor and memory. Consequently, a connection does not necessarily mean a direct, unimpeded connection unless otherwise noted.

A centralized communication module for a project portfolio management platform can allow for a number of benefits. This includes more convenient access to project communications for users such that a user is able to see all conversations about a project, a group of projects or part of a project in one glance. Users do not have to search their emails for the conversations about a particular project, because information is accessible from a single entry point and already filtered. The communication module can include existing email or chat solutions and because users are readily familiar with those they are easy to use.

In addition, the use of machine learning techniques helps relevant information reach to correct members of a team. It is typical for a portfolio or projects hosted on a project portfolio management platform to include much discussion and written information concerning the portfolio or projects. These discussions and written information can come in the form of an email or chat conversation. The responsibility of comprehending and categorizing this information can fall on the project manager of the portfolio or project. It is also the responsibility of the project manager to act accordingly on that information. For example, if course corrections are needed to ensure that product meets specifications, maintains a projected schedule, cost overruns, etc. A project manager usually acquires the skills necessary to make these decisions through many years of experience. And in some cases, the project manager and/or a project manager with those skills is not always readily available in a company workforce, especially a company workforce that is constantly and rapidly changing.

Consequently, some implementations of the disclosed techniques address such problems by leveraging an automated system to assist users in analysis of unstructured documents, correspondences and exchanges (e.g., instant messages, email, etc.) related to a portfolio, program, project, etc. As such, the communications related to the portfolio and/or project can be analyzed in a consistent manner. The information can be classified automatically so that it can be further leveraged in a common place by current and future members working on the portfolio and/or project. Because the information has been analyzed in a consistent manner, the value of such information increases and allows for identified risks and alerts to be presented to the stakeholder community. Moreover, if the system determines project criteria, milestones, thresholds, etc. are not being reached, members working on the project can be presented that information such that appropriate action can be taken.

A particular use case may illustrative. A user logs into a portfolio project management platform and goes to a centralized communication module to check if there are new messages and/or current discussions related to the projects the user is working on. The user had emailed a supplier the day before asking for a new invoice concerning a new industrial cake processing production line project. There is a new message on the communication module (e.g., a page configured for centralized communication in the portfolio project management platform) indicating that the supplier has sent the invoice. The user reads the invoice through a document viewer controlled by portfolio project management platform. Noting that the invoice is correct, the user adds the document to the project documents library for the industrial cake processing production line project. The user navigates to a different project concerning a cookie production line to see how the project is progressing. Having questions to share with the rest of the project team, the user decides to start a new discussion through their instant messaging system. He selects the relevant task, launches the communications module and sets the subject of the discussion. The management team members are selected as the default recipients. The user adds two more team members, types the message, and confirms its submission. After submitting the message, he sees a notification on his computer from his messaging system about the new discussion being started. Back from a meeting a moment later, the user navigates to the communication module and reads messages that have been posted in the user's absence. The communication module includes a notification that a potential delay has been identified and suggests creating a new risk or updating the project's Gantt chart. The user can select the related message for more information. Since the risk is clearly identified, he uses the portfolio project management platform to create the new risk for the related project. He then answers the conversation directly from the communication page.

In some implementations, messages and other communications on the portfolio project management platform are centralized and stored within one or more databases of the portfolio project management platform. For example, the communications can be stored in a database that is maintained locally by a customer of the portfolio project management platform. Alternatively, the communications can be stored in a cloud-based data management system controlled by the provider of the portfolio project management platform. In this way, using the communications module avoids having to switch between multiple communications channels controlled by different vendors (e.g., communication tools hosted by the portfolio project management platform, their email account, their company chat system, etc.) Furthermore, because the communication module centralizes all communication concerning a project, problems that would have gone unnoticed by some of the team members on the projects because they were not among the direct recipients of communication (a particular email conversation that might have been relevant to them) can now be noticed using the communication module. This particular problem can be compounded when many persons are involved in a project and the information is scattered across different sources. Consequently, users can now have a more global view of the project, and detect possible problems early on to minimize the consequences on the whole project.

Messages and other communications can be presented to the user in a variety of ways. In some implementations, the messages may be presented to the user via a module independent of a page associated with a particular portfolio or project. For example, messages related to project dedicated to the rollout of a new industrial cake processing production line can be displayed in a page functioning as a central hub for all communications concerning projects that the user is currently working on. As such, communications are available not only on a particular page associated with a project, but also centralized in single location to view all relevant communication to the user. A single location to view relevant communications mitigates the problem of a user needing to know many locations where to go to check for updates (e.g., a particular subject on a project, or different components of the software depending on the type of communication). A single location instead of multiple locations allows problems such as wasted user time or can lead to ignorance of tools not being as known and/or used by the user base as widely used as they could.

In other implementations, messages are presented to the user within a page associated with a particular portfolio or project. For example, a user may navigate to the project page dedicated to the rollout of a new industrial cake processing production line, and within that page, the user is presented with communications concerning the new industrial cake processing production line.

The communications system of portfolio project management platform can be capable of managing communications that are generated internally with a communications tool controlled by the portfolio project management platform (e.g., instant message, note, chat room, channel, etc.). As one illustration, an instant message sent from on team member to another team member using a real-time messaging system within the portfolio project management platform.

In addition to internal communications, the communications system of the portfolio project management platform can further manage communications that are generated external to the portfolio project management platform (e.g. emails generated by a third-party email client). As an illustration, a user may send an email to a coworker on the status of the rollout of a new industrial cake processing production line. This communication can be captured by the communications system of portfolio project management platform and added to the communications that can be presented within the portfolio project management platform. In some implementations, email originates from an email client that is part of the portfolio project management platform. But in other implementations, email can also originate from an email client that is independent and separate from the portfolio project management platform.

In some implementations, users are able to access only the communications according to their access rights on the project. For example, he users of portfolio project management platform may differ in their respective capacities, and the capacity of a particular user might be entirely determined by permissions for the current user. For example, when a project manager is using portfolio project management platform to interact with a project, the project manager has the viewing capacities allotted to that project. However, while a team member is using the portfolio project management platform to view the same project, that team member has the viewing capacities allotted for a team member. In this case, the viewing capacities of a team member may be more restricted than that of the project manager. Thus, different users will have different capabilities with regard to accessing and modifying communications associated with a project or portfolio, depending on a user's access rights.

In some implementations, if a user is explicitly identified as a recipient of the conversation by the sender, it can take precedence over a user's usual access level. That is, the user would be able to see the conversation and reply to it. For example, a conversation that would ordinarily only be visible to the project manager of a project might be visible to a team member that is directly mentioned by the project manager.

In some implementations, the communications module collects stores and analyzes all messages that are communicated through the portfolio project management platform. The messages can be analyzed using semantic analysis libraries for information extraction or topic modeling. For example, a topic concerning the status of the cake processing production line might be identified based on keywords in an email. In some implementations, the semantic libraries are trained using machine learning techniques on different types of corpora. In some cases, a generic library might be used for example Wikipedia entries. Alternatively, a corpus that is particular to an organization utilizing the portfolio project management platform might be used to train the semantic libraries. The types of documents that might analyzed include email history, instant messaging conversations history, project documents repository, etc. This can help the system take into account the specific terminology of a company or industry field and acquire better understanding of its environment, so as to improve the resulting analysis and tune it to a given client's data.

After analysis, messages can be classified. For example, an associated portfolio might be identified. In another example, project might be identified based on the content of the message and link (data relationship) between the new message and the project can be created. Actions can be suggested based on the

Upon analysis, in some cases the communications module can provide options on how best to act upon a particular issue that has been flagged. Actions can then be suggested to the user for direct integration with portfolio project management platform, such as creating a new risk for the identified project. In some implementation, alerts can be configured such that based on the themes identified in the messages an alert can be provided to users of a project.

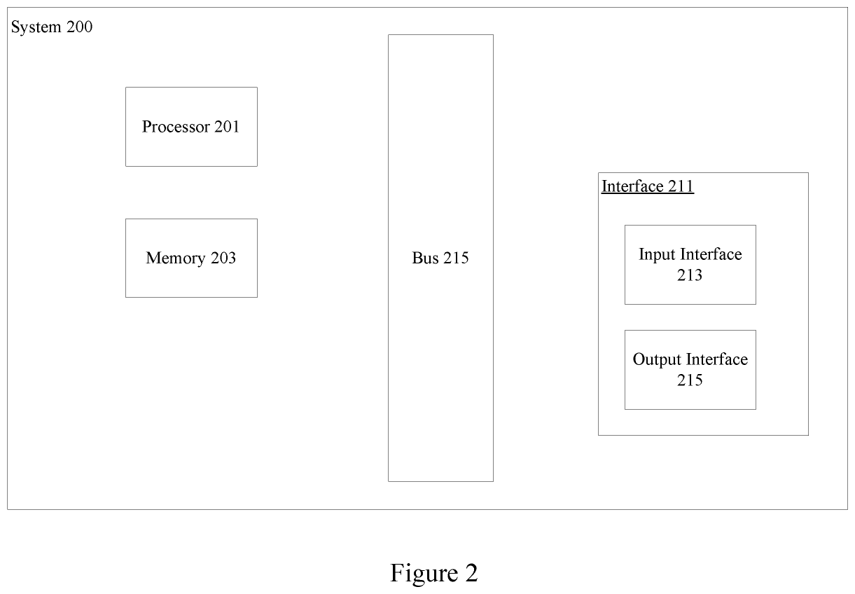

Various computing devices can implement the methods described. For instance, a mobile device, computer system, etc. can be used to generate artificially rendered images. With reference to FIG. 2, shown is a particular example of a computer system that can be used to implement particular examples of the present invention. For instance, the computer system 200 can be used to provide generate artificially rendered images according to various embodiments described above. In addition, the computer system 200 shown can represent a computing system on a mobile device. According to particular example embodiments, a system 200 suitable for implementing particular embodiments of the present invention includes a processor 201, a memory 203, an interface 211, and a bus 215 (e.g., a PCI bus). The interface 211 may include separate input interface 213 and output interface 215, or may be a unified interface supporting both operations. When acting under the control of appropriate software or firmware, the processor 201 is responsible for such tasks such as optimization. Various specially configured devices can also be used in place of a processor 201 or in addition to processor 201. The complete implementation can also be done in custom hardware. The interface 211 is typically configured to send and receive data packets or data segments over a network. Particular examples of interfaces the device supports include Ethernet interfaces, frame relay interfaces, cable interfaces, DSL interfaces, token ring interfaces, and the like.

In addition, various very high-speed interfaces may be provided such as fast Ethernet interfaces, Gigabit Ethernet interfaces, ATM interfaces, HSSI interfaces, POS interfaces, FDDI interfaces and the like. Generally, these interfaces may include ports appropriate for communication with the appropriate media. In some cases, they may also include an independent processor and, in some instances, volatile RAM.

The independent processors may control such communications intensive tasks as packet switching, media control and management.

According to particular example embodiments, the system 200 uses memory 203 to store data and program instructions and maintain a local side cache. The program instructions may control the operation of an operating system and/or one or more applications, for example. The memory or memories may also be configured to store received metadata and batch requested metadata.

Because such information and program instructions may be employed to implement the systems/methods described herein, the present invention relates to tangible, machine readable media that include program instructions, state information, etc. for performing various operations described herein. Examples of machine-readable media include hard disks, floppy disks, magnetic tape, optical media such as CD-ROM disks and DVDs; magneto-optical media such as optical disks, and hardware devices that are specially configured to store and perform program instructions, such as read-only memory devices (ROM) and programmable read-only memory devices (PROMs). Examples of program instructions include both machine code, such as produced by a compiler, and files containing higher level code that may be executed by the computer using an interpreter.

Although many of the components and processes are described above in the singular for convenience, it will be appreciated by one of skill in the art that multiple components and repeated processes can also be used to practice the techniques of the present disclosure.

While the present disclosure has been particularly shown and described with reference to specific embodiments thereof, it will be understood by those skilled in the art that changes in the form and details of the disclosed embodiments may be made without departing from the spirit or scope of the invention. It is therefore intended that the invention be interpreted to include all variations and equivalents that fall within the true spirit and scope of the present invention.

What is claimed is:

1. A method comprising:
maintaining a database of a plurality of messages associated with a project of a portfolio project management system;
providing a first one the messages to a first user of the portfolio project management system;
processing a request to generate a new message associated with the project, the request being received via a communications module of the portfolio project management system;
storing the new message in the database; and
providing the new message to a second user of the portfolio project management system.
